(19) United States
(12) Patent Application Publication
(10) Pub. No.: US 2024/0226814 A1
(43) Pub. Date: Jul. 11, 2024

(54) DRY-PROCESS MEMBRANE FOR FILTRATION

(71) Applicants: Celgard, LLC, Charlotte, NC (US); Entegris, Inc., Billerica, MA (US)

(72) Inventors: Eric R. White, Fort Mill, SC (US); Sina Bonyadi, Billerica, MA (US); Vinay Kalyani, Salem, NH (US)

(21) Appl. No.: 18/615,108

(22) Filed: Mar. 25, 2024

Related U.S. Application Data
(63) Continuation of application No. 18/693,083, filed on Jan. 1, 0001.
(60) Provisional application No. 63/246,093, filed on Sep. 20, 2021.
(60) Provisional application No. 63/343,347, filed on May 18, 2022.

(51) Int. Cl. B01D 69/02; B01D 61/02; B01D 61/14; B01D 69/12; B01D 71/26

(52) U.S. Cl. CPC B01D 69/02; B01D 61/027; B01D 61/145; B01D 69/1216; B01D 71/261; B01D 71/262; B01D 2325/02832; B01D 2325/02833; B01D 2325/04; B01D 2325/36

(57) ABSTRACT

A dry-process microporous membrane for filtration, wherein at least one layer of the membrane has an average pore size less than 0.035 microns, preferably between about 0.010 microns to about 0.020 microns, and a thickness less than 14 microns. The membrane may be used in an ultra-filtration or nano-filtration process. The membrane exhibits high dimensional stability.

The present application is a Continuation Application which claims priority to U.S. application Ser. No. 18/693,083, filed Mar. 18, 2024, which claims priority to U.S. PCT Application No. PCT/US2022/043676, filed Sep. 15, 2022, which claims priority to U.S. Provisional Application No. 63/246,093, filed Sep. 20, 2021 and U.S. Provisional Application No. 63/343,347, filed May 18, 2022, each of which is incorporated herein by reference in its entirety.

### FIELD

This application is directed to dry-process membranes suitable for use in filtration processes. Such processes may involve ultrafiltration or nano-filtration.

### BACKGROUND

It is desirable that membranes for nano-filtration and ulta-filtration exhibit one or more of the following properties mechanical stability, dimensional stability, flow rate suitable for commercial use, low contaminants, etc. Improvements in any or all of these areas are dessirable.

It is desirable that membranes for nano-filtration and ulta-filtration exhibit one or more of the following properties mechanical stability, dimensional stability, flow rate suitable for commercial use, low contaminants, etc. Improvements in any or all of these areas are desirable.

A major application of filter membranes is to remove unwanted materials from a flow of a useful fluid. Many gaseous and liquid fluids in industry are processed using filters, including environmental air, drinking water, fuels, liquid industrial solvents and processing fluids, industrial gases used for manufacturing or processing, and liquids that have medical or pharmaceutical uses. Unwanted materials that are removed from fluids include impurities and contaminants such as particles, microorganisms, and dissolved chemical species. Specific examples of impurity removal applications for filter membranes include their use to remove particles or bacteria from therapeutic solutions in the pharmaceutical industry, to process ultrapure aqueous and organic solvent solutions for use in microelectronics processing, and for air and water purification processes. Nano-filtration and/or ultra filtration are often used in these processes. It is desirable membranes for nano-filtration and ulta-filtration exhibit one or more of the following properties mechanical stability, dimensional stability, flow rate suitable for commercial use, low contaminants, etc. Improvements in any or all of these areas are desirable.

### SUMMARY

A dry-process microporous membrane for use in filtration is described herein. In some embodiments, at least one layer of the membrane has an average pore size less than 0.035 microns and a thickness less than 14 microns. The average pore size of the single layer, in some embodiments, may be less than 0.03 microns, less than 0.025 microns, or less than 0.020 microns. In some preferred embodiments, the average pore size may be from about 0.010 to about 0.020 microns. In some preferred embodiments, the average pore size may be from about 0.010 to about 0.020 microns. In some embodiments, the average pore size of at least one layer may be less than 0.035 microns and the thickness of the layer may be less than 12 microns. The average pore size of the single layer, in some embodiments, may be less than 0.03 microns, less than 0.025 microns, or less than 0.020 microns. In some preferred embodiments, the average pore size may be from about 0.010 to about 0.020 microns. In some embodiments, the average pore size of at least one layer may be less than 0.035 microns and the thickness of the layer may be less than 10 microns. The average pore size of the single layer, in some embodiments, may be less than 0.03 microns, less than 0.025 microns, or less than 0.020 microns. In some preferred embodiments, the average pore size may be from about 0.010 to about 0.020 microns.

In some embodiments described herein above, the at least one layer may be a polypropylene-containing layer.

In some embodiments described above, the membrane may be a monolayer membrane, a bilayer membrane, a tri-layer membrane, or a multi-layer membrane. The bi-layer, tri-layer, or multi-layer membranes may be formed by laminating two or more layers, co-extruding two or more layers, or a combination of lamination and extrusion steps.

In some of the embodiments described above, the membrane may be a tri-layer membrane comprising a polypropylene-containing layer, a polyethylene-containing layer, and a polypropylene-containing layer in that order. In some embodiments described above, the membrane may be a tri-layer membrane comprising a polyethylene-containing layer, a polypropylene-containing layer, and a polyethylene-containing layer.

In some embodiments described hereinabove, the thickness of the membrane is less than 14 microns, less than 12 microns, or less than 10 microns.

In some embodiments, the membrane is translucent or transparent. In some embodiments, the membrane may have a blue tint and be translucent or transparent.

In some embodiments described hereinabove, shrinkage of the membrane at 90° C. for 1 hour is less than 25%, less than 20%, less than 15%, less than 10%, or less than 5%.

In some embodiments described hereinabove, the membrane has a flow time from 400 to 40,000 seconds. Flow time may be measured using isopropyl alcohol (IPA), wherein the flow time is the time to flow 500 ml of isopropyl alcohol at a temperature of 21° C. and a pressure of 0.1 MPa through a 47 mm disc of the membrane having an area of 12.5 cm².

In some embodiments, the membrane may have a hydrophilic treatment or coating on at least one side thereof. This may help with filtration where water or alcohol are used as the solvents.

In another aspect, an ultra-filtration or a nano-filtration process is described. One step of the process is filtering a solvent through the membrane described hereinabove.

In another element, a filtration element is described which comprises a membrane as described hereinabove and a housing.

### BRIEF DESCRIPTION OF THE DRAWINGS

FIG. 1 is an SEM of a dry-process microporous membrane as described herein.

### DESCRIPTION

The subject matter of aspects of the present disclosure is described with specificity herein to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step” and/or “block” can be used herein to connote different elements of methods employed, the terms should not be interpreted as implying any particular order among or between various steps disclosed herein unless and except when the order of individual steps is explicitly described.

Accordingly, embodiments described herein can be understood more readily by reference to the following detailed description, examples, and figures. Elements, apparatus, and methods described herein, however, are not limited to the specific embodiments presented in the detailed description, examples, and figures. It should be recognized that the exemplary embodiments herein are merely illustrative of the principles of the invention. Numerous modifications and adaptations will be readily apparent to those of skill in the art without departing from the spirit and scope of the invention.

In addition, all ranges disclosed herein are to be understood to encompass any and all subranges subsumed therein. For example, a stated range of “1.0 to 10.0” should be considered to include any and all subranges beginning with a minimum value of 1.0 or more and ending with a maximum value of 10.0 or less, e.g., 1.0 to 5.3, or 4.7 to 10.0, or 3.6 to 7.9.

All ranges disclosed herein are also to be considered to include the end points of the range, unless expressly stated otherwise. For example, a range of “between 5 and 10” or “5 to 10” or “5-10” should generally be considered to include the end points 5 and 10.

Further, when the phrase “up to” is used in connection with an amount or quantity; it is to be understood that the amount is at least a detectable amount or quantity. For example, a material present in an amount “up to” a specified amount can be present from a detectable amount and up to and including the specified amount.

Additionally, in any disclosed embodiment, the terms “substantially,” “approximately,” and “about” may be substituted with “within [a percentage] of” what is specified, where the percentage includes 0.1, 1, 5, and 10 percent.

A dry-process microporous membrane for use in filtration is described herein. In some embodiments, at least one layer of the membrane has an average pore size less than 0.035 microns and a thickness less than 14 microns, less than 13 microns, less than 12 microns, less than 11 microns, less than 10 microns, less than 9 microns, less than 8 microns, less than 7 microns, less than 6 microns, less than 5 microns, less than 4 microns, less than 3 microns, less than 2 microns, or less than 1 microns. In some embodiments, at least one layer of the membrane has an average pore size less than 0.030 microns and a thickness less than 14 microns, less than 13 microns, less than 12 microns, less than 11 microns, less than 10 microns, less than 9 microns, less than 8 microns, less than 7 microns, less than 6 microns, less than 5 microns, less than 4 microns, less than 3 microns, less than 2 microns, or less than 1 microns. In some embodiments, at least one layer of the membrane has an average pore size less than 0.025 microns and a thickness less than 14 microns, less than 13 microns, less than 12 microns, less than 11 microns, less than 10 microns, less than 9 microns, less than 8 microns, less than 7 microns, less than 6 microns, less than 5 microns, less than 4 microns, less than 3 microns, less than 2 microns, or less than 1 microns. In some embodiments, at least one layer of the membrane has an average pore size less than 0.020 microns and a thickness less than 14 microns, less than 13 microns, less than 12 microns, less than 11 microns, less than 10 microns, less than 9 microns, less than 8 microns, less than 7 microns, less than 6 microns, less than 5 microns, less than 4 microns, less than 3 microns, less than 2 microns, or less than 1 microns. In some embodiments, at least one layer of the membrane has an average pore size less than 0.015 microns and a thickness less than 14 microns, less than 13 microns, less than 12 microns, less than 11 microns, less than 10 microns, less than 9 microns, less than 8 microns, less than 7 microns, less than 6 microns, less than 5 microns, less than 4 microns, less than 3 microns, less than 2 microns, or less than 1 microns. In some embodiments, at least one layer of the membrane has an average pore size less than 0.010 microns and a thickness less than 14 microns, less than 13 microns, less than 12 microns, less than 11 microns, less than 10 microns, less than 9 microns, less than 8 microns, less than 7 microns, less than 6 microns, less than 5 microns, less than 4 microns, less than 3 microns, less than 2 microns, or less than 1 microns. In some embodiments, at least one layer of the membrane has an average pore size less than 0.005 microns and a thickness less than 14 microns, less than 13 microns, less than 12 microns, less than 11 microns, less than 10 microns, less than 9 microns, less than 8 microns, less than 7 microns, less than 6 microns, less than 5 microns, less than 4 microns, less than 3 microns, less than 2 microns, or less than 1 microns. In some preferred embodiments, at least one layer of the membrane has an average pore size from about 0.010 to about 0.020 microns, and a thickness less than 14 microns, less than 13 microns, less than 12 microns, less than 11 microns, less than 10 microns, less than 9 microns, less than 8 microns, less than 7 microns, less than 6 microns, less than 5 microns, less than 4 microns, less than 3 microns, less than 2 microns, or less than 1 microns.

In some embodiments described herein above, the at least one layer may be a polypropylene-containing layer. The polypropylene-containing layer may be a layer that comprises, consists of, or consists essentially or polypropylene homopolymer, co-polymer, or combination thereof. The polypropylene—containing layer may comprise, consist of, or consist essentially of 50% or more of polypropylene homopolymer, co-polymer, or combination thereof.

In some embodiments described above, the membrane may be a monolayer membrane, a bilayer membrane, a tri-layer membrane, or a multi-layer membrane. A multi-layer membrane may have four or more layers. The bi-layer, tri-layer, or multi-layer membranes may be formed by laminating two or more layers, co-extruding two or more layers, or a combination of lamination and extrusion steps.

In some embodiments, the membrane may have a total thickness of less than 20 microns, less than 19 microns, less than 18 microns, less than 17 microns, less than 16 microns, less than 15 microns, less than 14 microns, less than 13 microns, less than 12 microns, less than 11 microns, less than 10 microns, less than 9 microns, less than 8 microns, less than 7 microns, less than 6 microns, less than 5 microns, less than 4 microns, less than 3 microns, less than 2 microns, or less than 1 micron.

For example, in one embodiment, the membrane may be a monolayer membrane where the at least one layer of the membrane has an average pore size less than 0.035(preferably between 0.010 and 0.020 microns) has a thickness of 7 microns, and the total membrane thickness is 7 microns. The membrane may be a bilayer where the at least one layer of the membrane has an average pore size less than 0.035 (preferably between about 0.010 and 0.020 microns) has a thickness of 4 microns and the total membrane thickness is 8 microns.

In some of the embodiments described above, the membrane may be a tri-layer membrane comprising a polypropylene-containing layer, a polyethylene-containing layer, and a polypropylene-containing layer in that order. In some embodiments described above, the membrane may be a tri-layer membrane comprising a polyethylene-containing layer, a polypropylene-containing layer, and a polyethylene-containing layer. The polyethylene-containing layer may be a layer that comprises, consists of, or consists essentially or polyethylene homopolymer, co-polymer, or combination thereof. The polyethylene—containing layer may comprise, consist of, or consist essentially of 50% or more of polyethylene homopolymer, co-polymer, or combination thereof.

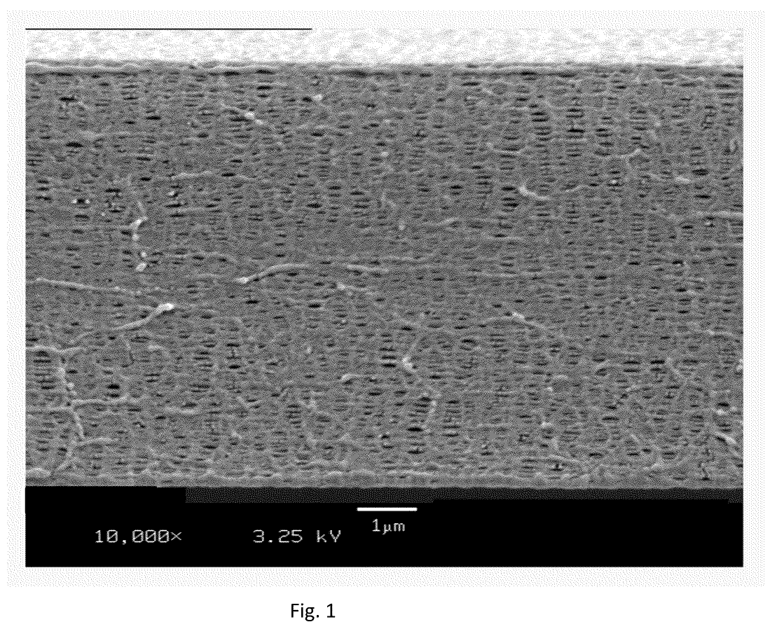

A dry-process membrane, as understood by one of ordinary skill in the art, is a membrane formed without the use of solvents or oils to form pores. In some embodiments, membranes formed by using particulate pore formers may also be excluded from dry-process membranes. Such membranes may include beta-nucleated biaxially oriented polypropylene (BNBOPP) membranes. Dry-process membranes have a distinct uniform pore structure recognizable by those skilled in the art. See, for example, FIG. 1, which shows a uniaxially stretched dry-process membrane. As can be seen from FIG. 1, dry-process films have elongated or slit-shaped pores. Pores of a biaxially-stretched dry-process membrane may be too large for use in ultrafiltration or nano-filtration applications. In some embodiments described hereinabove, shrinkage of the membrane at 90° C. for 1 hour is less than 25%, less than, less than 20%, less than 15%, less than 10%, or less than 5%, less than 4%, less than 3%, less than 2%, or less than 1%. Low shrinkage is indicative of high dimensional stability, which is crucial. Shrinkage of the membrane in filtering application or during assembly of a filter may cause the membrane to rip, tear or modify other properties such that performance is no longer sufficient and/or predictable. Shrinkage is measured by measuring the membrane (L1), placing the membrane in a 90° C. oven for one hour unrestrained, measuring the membrane after being in the oven (L2), and calculating shrinkage using the following formula 1.

(L1-L2/L1)×100 (1)

The flow time using IPA may be at or above 400 seconds, in the range of from about 400 seconds to about 40,000 seconds, 500 seconds to about 40,000 seconds, 600 seconds to about 40,000 seconds, 700 seconds to about 40,000 seconds, 800 seconds to about 40,000 seconds, 900 seconds to about 40,000 seconds, 1,000 seconds to about 40,000 seconds, 2,000 seconds to about 40,000 seconds, 3,000 seconds to about 40,000 seconds, 4,000 seconds to about 40,000 seconds, 5,000 seconds to about 40,000 seconds, 6,000 seconds to about 40,000 seconds, 7,000 seconds to about 40,000 seconds, 8,000 seconds to about 40,000 seconds, 9,000 seconds to about 40,000 seconds, 10,000 seconds to about 40,000 seconds, in the range from about 11,000 seconds to about 40,000 seconds, 17,000 seconds to about 40,000 seconds, 20,000 seconds to about 40,000 seconds, 25,000 seconds to about 40,000 seconds, 30,000 seconds to about 40,000 seconds, or 35,000 seconds to about 40,000 seconds. Flow time may be flow time using IPA (isopropyl alcohol), wherein the flow time is the time to flow 500 ml of isopropyl alcohol (IPA) at a temperature of 21° C. and a pressure of 0.1 MPa through a 47 mm disc of the membrane having an area of 12.5 cm².

### EXAMPLES

Example 1 is a dry-process monolayer polypropylene-containing membrane having a total thickness of 7 microns.

Example 2 is a dry-process tri-layer membrane comprising three polypropylene-containing layers with a total thickness of 6 microns. The polypropylene-containing layer with the smallest pore size is approximately 2 microns in thickness with a pore size of 22.

Example 3 is a dry-process membrane with a pore size of 20

Comparative Example 1 is a dry-process monolayer polypropylene-containing membrane having a total thickness of 7 microns.

Comparative Example 2 is a dry-process tri-layer membrane comprising a polypropylene-containing layer, a polyethylene-containing layer, and a polypropylene-containing layer in that order. The total thickness of the membrane is 20 microns, with the PP-containing layer thicknesses adding up to 14 microns. PP average pore size is 35 nm.

| Property | nits | Example 1 | Example 2 | [symbol] mple 3 | [symbol] mparative 1 | [symbol] mparative 2 |
|---|---|---|---|---|---|---|
| Basis | g/m2 | 3.6 | 3.1 | <5 | 3.3 | 3.5 |
| Weight | | | | | | |
| MD | % | 3 | 4 | <5 | 17 | 1 |
| Shrinkage, | | | | | | |
| 90° C. | | | | | | |
| Thickness | μm | 7 | 6 | [symbol] s than 10 | 7 | 7 |
| Limiting | nm | 23 | 22 | Between 10 | 23 | 40 |
| Layer | | | | nm and | | |
| Pore Size | | | | 20 nm | | |

[symbol]

indicates data missing or illegible when filed

Comparative Example 2 has the issue of the pores being too big for nan-filtration or ultra-filtration processes. Comparative Example 1 has a high shrinkage, which makes it unsuitable for use due to low dimensional stability. Shrinkage of the membrane in application or during assembly may cause the membrane to rip, tear or modify other properties such that performance is no longer sufficient and/or predictable. Examples 1 and 2 have high dimensional stability (e.g., low shrinkage), and small enough pores for use in nano-filtration or ultra-filtration processes (including filtration of gas or liquid).

1-53. (canceled)

54. filter product adapted to filter solvent for use in microelectronics processing comprising:
a dry process membrane contained in a filter housing,
wherein at least one layer of the dry-process microporous membrane has:
(i) an average pore size less than 0.035 microns, and
(ii) a thickness less than 14 microns.

55. The filter product of claim 54, wherein the average pore size is less than 0.030 microns.

56. The filter product of claim 54, wherein the average pore size is less than 0.025 microns.

57. The filter product of claim 54, wherein the average pore size is less than 0.020 microns.

58. The filter product of claim 54, wherein the average pore size is from 0.010 microns to 0.020 microns.

59. The filter product of claim 54, wherein the membrane has a thickness less than 12 microns.

60. The filter product of claim 54, wherein the membrane has a thickness less than 10 microns.

61. The filter product of claim 54, wherein the at least one layer is a polypropylene-containing layer.

62. The filter product of claim 54, wherein the dry-process microporous membrane is a monolayer membrane, a bilayer membrane, tri-layer membrane, or multi-layer membrane.

63. The filter product of claim 62, wherein the dry-process microporous membrane is a tri-layer membrane having a polypropylene-containing layer, a polyethylene-containing layer, and a polypropylene-containing layer in that order.

64. The filter product of claim 63, wherein the dry-process microporous membrane has a total thickness less than 14 microns, less than 12 microns, or less than 10 microns.

65. The filter product of claim 62, wherein the dry-process microporous membrane is a tri-layer membrane having a polyethylene-containing layer, a polypropylene-containing layer, and a polyethylene-containing layer in that order.

66. The filter product of claim 65, wherein the dry-process microporous membrane has a total thickness less than 20 microns, less than 19 microns, less than 18 microns, less than 17 microns, less than 16 microns, less than 15 microns, less than 14 microns, less than 12 microns, or less than 10 microns.

67. The filter product of claim 54, wherein the dry-process microporous membrane has a flow time using IPA from 400 to 40,000 seconds.

68. The filter product of claim 54, wherein the dry-process microporous membrane comprises a hydrophilic treatment or coating on at least one side thereof.

69. A method of filtering solvent (e.g., a method of filtering solvent used for microelectronics processing, e.g., a nanofiltration method for filtering a solvent used for microelectronics processing, e.g., an ultrafiltration method for filtering solvent used for microelectronics processing), the method comprising:
flowing the solvent through a filter product having a dry-process microporous membrane contained in a filter housing,
wherein at least one layer of the dry-process microporous membrane has:
(i) an average pore size less than 0.035 microns, and
(ii) a thickness less than 14 microns.

70. The method of claim 69, wherein the dry-process microporous membrane average pore size is from 0.010 microns to 0.020 microns.

71. The method of claim 69, wherein the dry-process microporous membrane average pore size is less than 0.030 microns.

72. The method of claim 69, wherein the dry-process microporous membrane average pore size is less than 0.025 microns.

73. The method of claim 69, wherein the dry-process microporous membrane average pore size is less than 0.020 microns.

74. The method of claim 69, wherein the dry-process microporous membrane average pore size is from 0.010 microns to 0.020 microns.

75. The method of claim 69, wherein the membrane has a thickness less than 12 microns.

76. The method of claim 69, wherein the membrane has a thickness less than 10 microns.

77. The method of claim 69, wherein the at least one layer is a polypropylene-containing layer.

78. The method of claim 69, wherein the at least one layer is a polypropylene-containing layer.

79. The method of claim 69, wherein the dry-process microporous membrane is a monolayer membrane, a bilayer membrane, tri-layer membrane, or multi-layer membrane.

80. The method of claim 79, wherein the dry-process microporous membrane is a tri-layer membrane having a polypropylene-containing layer, a polyethylene-containing layer, and a polypropylene-containing layer in that order.

81. The method of claim 80, wherein the dry-process microporous membrane has a total thickness less than 14 microns, less than 12 microns, or less than 10 microns.

82. The method of claim 79, wherein the dry-process microporous membrane is a tri-layer membrane having a polyethylene-containing layer, a polypropylene-containing layer, and a polyethylene-containing layer in that order.

83. The method of claim 82, wherein the dry-process microporous membrane has a total thickness less than 14 microns, less than 12 microns, or less than 10 microns.

84. The method of claim 69, wherein the dry-process microporous membrane comprises a hydrophilic treatment or coating on at least one side thereof.

85. The method of claim 69, wherein the solvent is an aqueous solvent, an alcohol, or an organic solvent.
